(19) United States
(12) Patent Application Publication
(10) Pub. No.: US 2024/0276374 A1
(43) Pub. Date: Aug. 15, 2024

(54) POWER SAVINGS AND MULTI-SET INDICATION WITH SPS OCCASION FOR MULTI-PDSCH TRANSMISSIONS

(71) Applicant: QUALCOMM Incorporated, San Diego, CA (US)

(72) Inventors: Diana MAAMARI, San Diego, CA (US); Prashanth Haridas HANDE, San Diego, CA (US); Ahmed ELSHAFIE, San Diego, CA (US); Mickael MONDET, Louannec (FR); Huilin XU, Temecula, CA (US)

(21) Appl. No.: 18/169,179

(22) Filed: Feb. 14, 2023

(51) Int. Cl. H04W 52/02; H04W 72/11

(52) U.S. Cl. CPC H04W 52/0229; H04W 72/11

(57) ABSTRACT

Apparatus, methods, and computer program products for wireless communication are provided. An example method may include receiving, from a second network entity, a configuration for at least one SPS occasion, where each SPS occasion of the at least one SPS occasion includes at least one PDSCH occasion, and where the configuration for the at least one SPS occasion includes information indicative of a quantity of the at least one SPS occasion. The example method may further include receiving, from the second network entity, data in the at least one SPS occasion. The example method may further include performing at least one action, where the at least one action includes: enter, based on the quantity, a first power state, or remain, based on the quantity, in a second power state.

### TECHNICAL FIELD

The present disclosure relates generally to communication systems, and more particularly, to wireless communication systems with semi-persistent scheduling (SPS) occasion.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus which may be a first network entity (such as user equipment (UE)) are provided. The apparatus may include a memory and at least one processor coupled to the memory. The at least one processor may be configured to receive, from a second network entity, a configuration for at least one semi-persistent scheduling (SPS) occasion, where each SPS occasion of the at least one SPS occasion com includes at least one physical downlink shared channel (PDSCH) occasion, and where the configuration for the at least one SPS occasion includes information indicative of a quantity of the at least one SPS occasion. The at least one processor may be configured to receive, from the second network entity, data in the at least one SPS occasion. The at least one processor may be configured to perform at least one action, where the at least one action includes: enter, based on the quantity, a first power state, or remain, based on the quantity, in a second power state.

In another aspect of the disclosure, a method, a computer-readable medium, and an apparatus which may be a first network entity (such as a base station) are provided. The apparatus may include a memory and at least one processor coupled to the memory. The at least one processor may be configured to transmit, for a second network entity, a configuration for at least one SPS occasion, where each SPS occasion of the at least one SPS occasion includes at least one PDSCH occasion, and where the configuration for the at least one SPS occasion includes information indicative of a quantity of the at least one SPS occasion. The at least one processor may be configured to transmit, for the second network entity based on the quantity, data in the at least one SPS occasion.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of protocol data unit (PDU) set transmission in bursts.

FIG. 5 is a diagram illustrating an example of extended reality (XR) video data transmission.

FIG. 6 is a diagram illustrating example communications between a network entity and a UE.

FIG. 7 is a diagram illustrating an example of transmission of multiple SPS occasion.

FIG. 8 is a diagram illustrating an example of transmission of multiple SPS occasion.

FIG. 9 is a diagram illustrating an example of a sleep indication included in an SPS occasion.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

FIG. 15 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

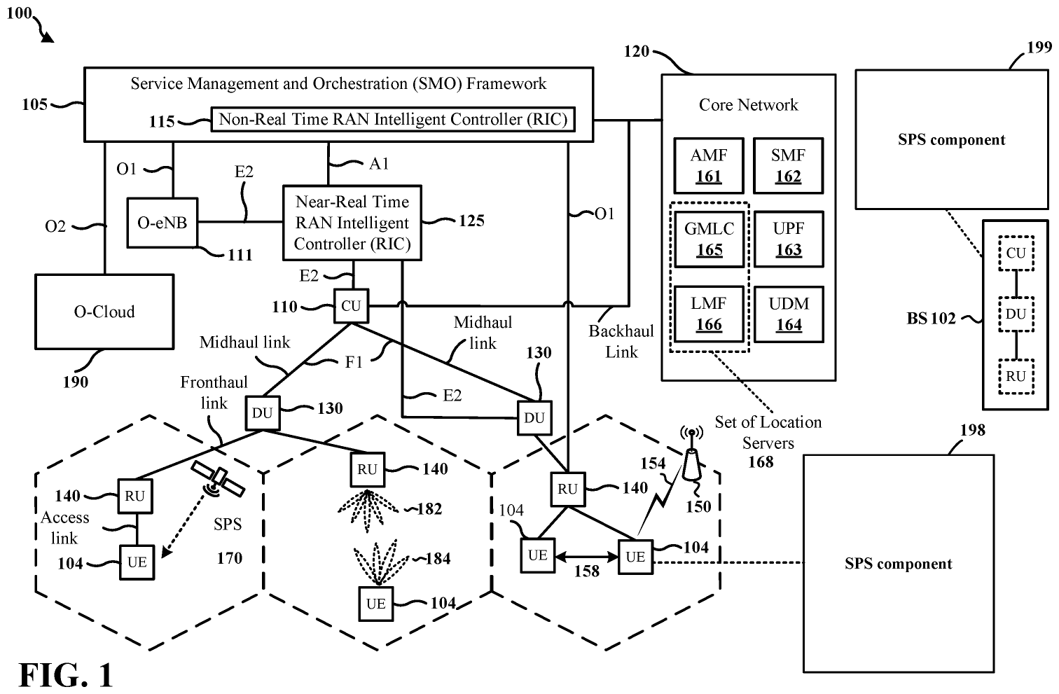

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface).

For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like.

When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include an SPS component 198. In some aspects, the SPS component 198 may be configured to receive, from a second network entity, a configuration for at least one SPS occasion, where each SPS occasion of the at least one SPS occasion includes at least one PDSCH occasion, and where the configuration for the at least one SPS occasion includes information indicative of a quantity of the at least one SPS occasion. In some aspects, the SPS component 198 may be further configured to receive, from the second network entity, data in the at least one SPS occasion. In some aspects, the SPS component 198 may be further configured to perform at least one action, where the at least one action includes: enter, based on the quantity, a first power state, or remain, based on the quantity, in a second power state.

In certain aspects, the base station 102 may include an SPS component 199. In some aspects, the SPS component 199 may be configured to transmit, for a second network entity, a configuration for at least one SPS occasion, where each SPS occasion of the at least one SPS occasion includes at least one PDSCH occasion, and where the configuration for the at least one SPS occasion includes information indicative of a quantity of the at least one SPS occasion. In some aspects, the SPS component 199 may be further configured to transmit, for the second network entity based on the quantity, data in the at least one SPS occasion.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

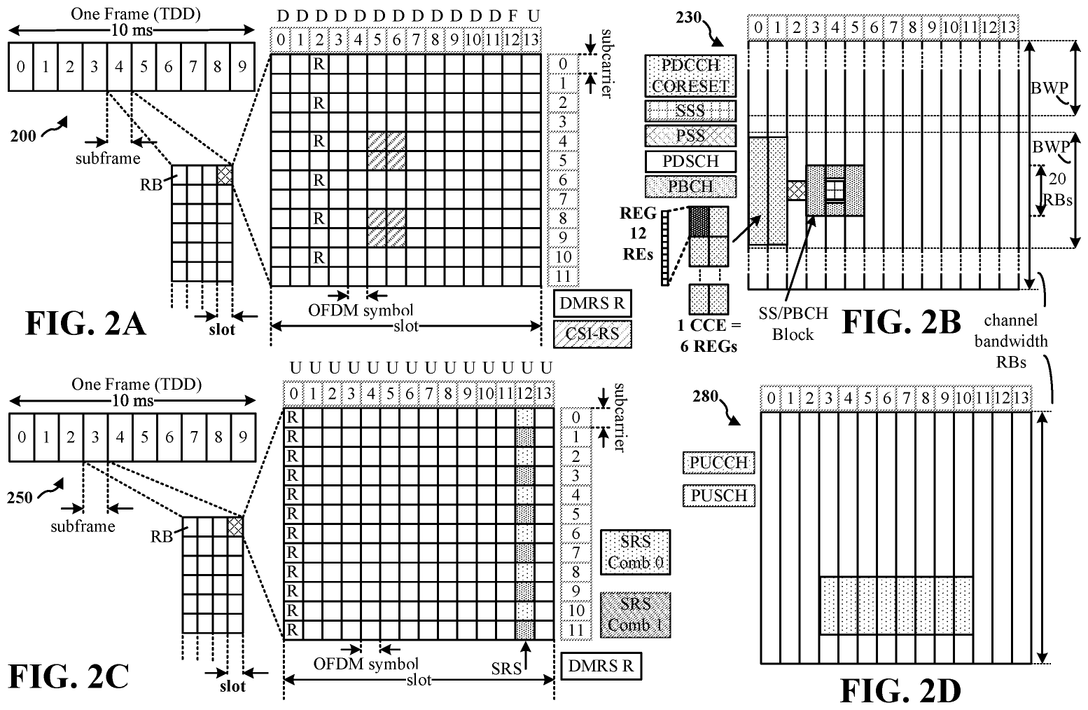

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

### Table 1: Numerology, SCS, and CP

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}·15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

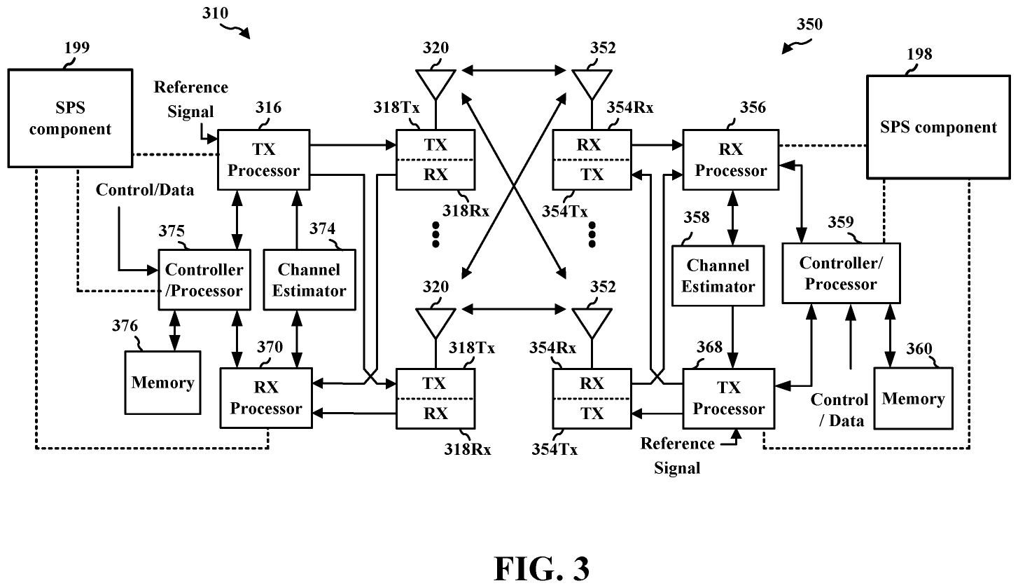

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality. The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with SPS component 198 of FIG. 1.

At least one of the TX processor 316, the RX processor 370, and the controller/processor 375 may be configured to perform aspects in connection with SPS component 199 of FIG. 1.

As used herein, the term “power state” may refer to an operational mode, such as an RRC state associated with a UE. As used herein, the term “sleep state” may refer to a power saving mode, such as a deep sleep state (where all or a subset of types of reception or transmission at the UE may be off), a light sleep state (where a smaller subset of reception or transmission at the UE may be off), or the like. As used herein, the term “awake state” may refer to an active state (which may also be referred to as an “active power state or a “reception mode”) at the UE where the UE may be actively monitoring and receiving PDCCH or PDSCH.

As used herein, the term “SPS occasion” may refer to one or more SPS scheduled PDSCH occasions that may be scheduled by DCI. A DCI may schedule a single SPS occasion or multiple SPS occasions. As used herein, the term “data in SPS occasion” may refer to various types of data, such as XR data or other types of data, that may be grouped in PDU sets (PDU set may also be referred to as an “application data unit (ADU).” As used herein, the term “PDSCH occasion” may refer to a time domain location associated with a PDSCH transmission that may carry one or more PDUs. There may be several instances (which may also be referred to as “repetition”) of PDSCH occasions in a single SPS occasion. A PDU set may include one or more PDUs carrying the payload of one unit of information generated at the application level (e.g., a frame, a video slice, or a different type of unit for an application).

As used herein, the term “burst” may refer to a set of PDU sets that may be associated with a same data session, such as a same XR session. A burst may be a large amount of data (e.g., over a threshold) transmitted over a short period of time (e.g., smaller than a threshold) for the data session. There may be several instances (which may also be referred to as “repetition”) of SPS occasions in a single burst. As used herein, the term “configuration of at least one SPS occasion” may refer to a configuration for SPS that includes an indication of the quantity of SPS occasions (or the quantity of PDSCH occasions, the quantity of the ADUs, or the like) to complete the transmission for a burst.

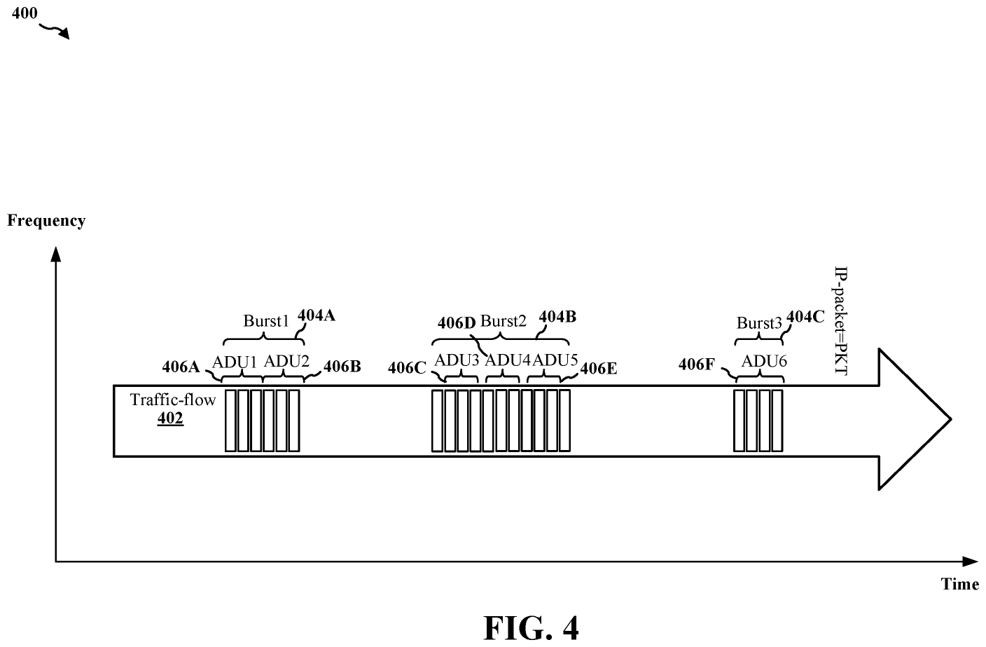

FIG. 4 is a diagram 400 illustrating an example of PDU set transmission in bursts. As illustrated in FIG. 4, for a traffic flow 402 associated with an application, there may be a first burst 404A, a second burst 404B, and a third burst 404C. The first burst 404A may include a first ADU 406A and a second ADU 406B, which may each include several PDUs. The second burst 404B may include an ADU 406C, an ADU 406D, and an ADU 406E, which may each include several PDUs. The second burst 404B may also include a PDU that does not belong to the ADU 406C, the ADU 406D, or the ADU 406E. The third burst 404C may include a single ADU 406F, which may include several PDUs. The PDUs may be IP packets.

Aspects provided herein may enable the network to indicate a quantity of SPS occasions or PDUs or an end of the SPS occasions or the PDUs to a UE. Based on the knowledge of the quantity of SPS occasions or PDUs or the end of the SPS occasions or the PDUs, the UE may dynamically skip PDCCH monitoring after the last PDU of the SPS occasions is delivered, resulting in less power usage at the UE. In some aspects, a network entity may be aware of the quantity of SPS occasions or PDUs or the end of the SPS occasions or the PDUs based on knowledge from the core network.

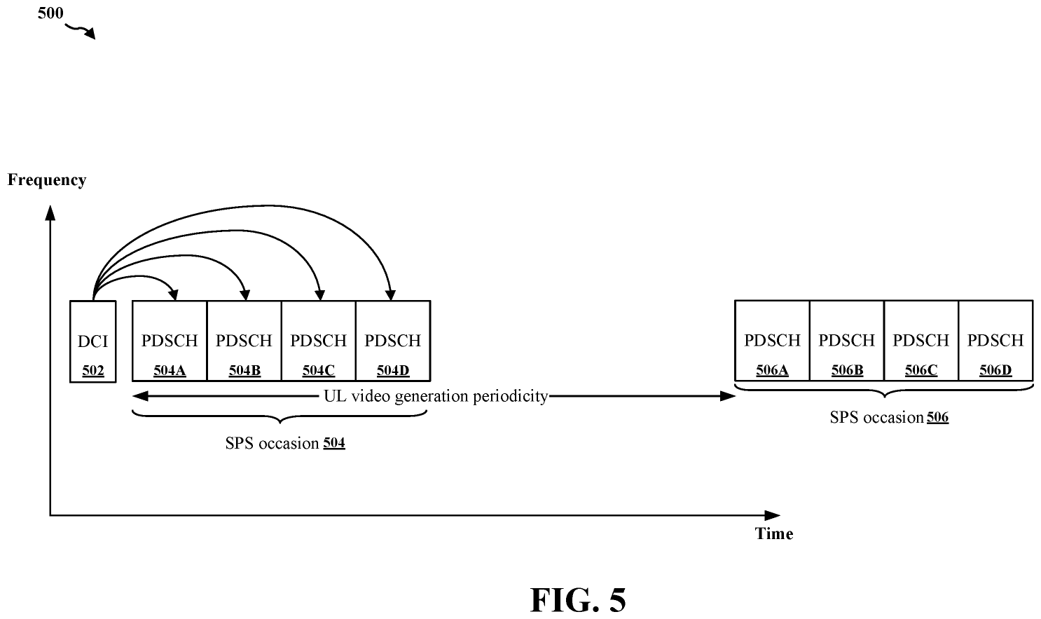

FIG. 5 is a diagram 500 illustrating an example of XR video data transmission. In some aspects, the single DCI 502 may activate a single configured grant (CG) or SPS occasion with multiple PUSCH or PDSCH occasions. For example, as illustrated in FIG. 5, a single DCI 502 may schedule an SPS occasion 504 that may include one or more PDSCH occasions including PDSCH occasion 504A, PDSCH occasion 504B, PDSCH occasion 504C, and PDSCH occasion 504D. Each PDSCH occasion may include one or more PDUs. In some aspects, the single DCI 502 may be a multiple PDSCH scheduling DCI. In some aspects, the single DCI 502 may activate multiple CG or SPS occasions that may each include multiple PUSCH or PDSCH occasions. For example, as illustrated in FIG. 5, the single DCI 502 may also schedule an SPS occasion 506 that may include one or more PDSCH occasions including PDSCH occasion 506A, PDSCH occasion 506B, PDSCH occasion 506C, and PDSCH occasion 506D. A time difference between the beginning of the SPS occasion 504 and the beginning of the SPS occasion 506 may correspond to a video generation periodicity associated with the XR video.

A burst may include multiple SPS occasions which may each include multiple PDSCH occasions. To facilitate power saving at the UE, the UE may enter a sleep state at the end of the burst. Aspects provided herein may enable the UE to be aware of where the end of the burst is, enabling power saving.

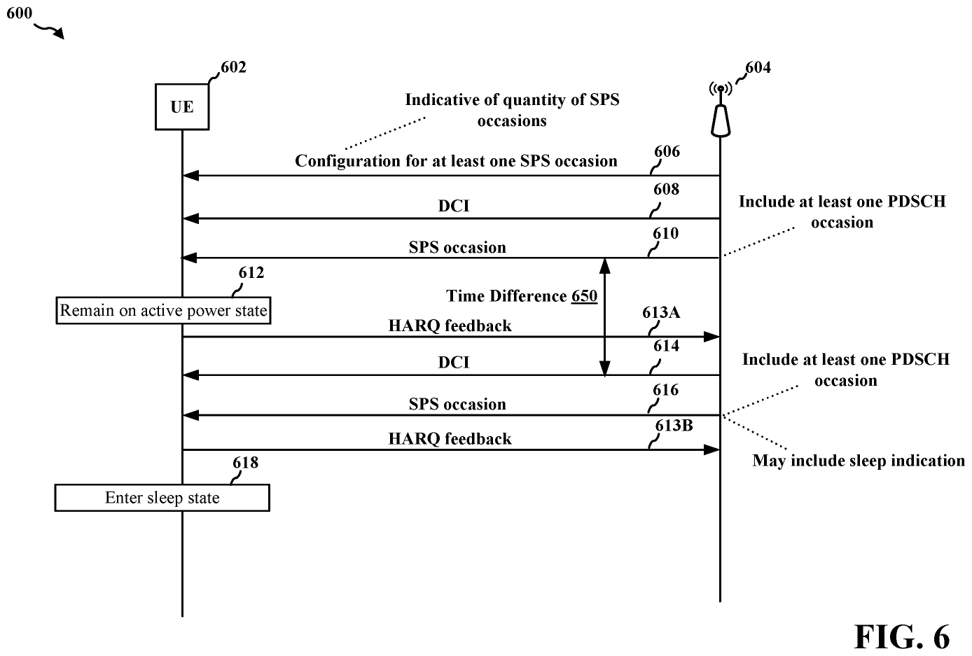

FIG. 6 is a diagram 600 illustrating example communications between a network entity 604 and a UE 602. In some aspects, a network entity may be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC.

As illustrated in FIG. 6, the network entity 604 may transmit configuration for at least one SPS occasion 606 to the UE 602. In some aspects, the configuration for at least one SPS occasion 606 may include information indicative of a quantity of SPS occasions (or the quantity of PDSCH occasions, the quantity of the ADUs, or the like) to complete the transmission for an upcoming burst.

In some aspects, the information indicative of a quantity of SPS occasions may be a multi-setSPSoccasions information element (IE), which may represent the quantity of subsequent SPS occasions other than the initial SPS occasion in the burst. In some aspects, based on the configuration for at least one SPS occasion 606, the UE 602 may determine the quantity of SPS occasions (sets of PDSCH occasions) to complete the burst transmission. In some aspects, as an example, the UE 602 may determine to enter the sleep state after transmission of the burst or remain awake after transmission of the burst. In some aspects, as an example, the UE 602 may determine to remain awake after receiving an SPS occasion based on the SPS occasion is not a last SPS occasion (e.g., based on determining that the UE has not finished receiving all of the SPS occasions based on the quantity of SPS occasions).

In some aspects, the configuration for the at least one SPS occasion 606 may be transmitted from the network entity 604 to the UE 602 in a DCI. As illustrated in FIG. 6, the UE may receive DCI 608 from the network entity 604. In some aspects, the DCI 608 may include configuration for the at least one SPS occasion 606. In some aspects, the configuration for the at least one SPS occasion 606 may be transmitted from the network entity 604 to the UE 602 in an RRC configuration. In some aspects, the configuration for the at least one SPS occasion 606 may be transmitted from the network entity 604 to the UE 602 in a MAC control element (MAC-CE). In some aspects, the DCI 608 is configured to schedule (e.g., include scheduling information that may be indicative of time and frequency resources for) all of the SPS occasions in the burst, such as SPS occasion 610 and SPS occasion 616 (which may each include at least one PDSCH occasions).

In some aspects, the DCI 608 is configured to schedule (e.g., include scheduling information that may be indicative of time and frequency resources for) a first (e.g., initial) SPS occasion in the burst, such as the SPS occasion 610. In aspects where the DCI 608 is configured to schedule the first SPS occasion in the burst, such as the SPS occasion 610 but not subsequent SPS occasions, a separate DCI 614 may be transmitted from the network entity 604 to the UE 602 to schedule the SPS occasion 616.

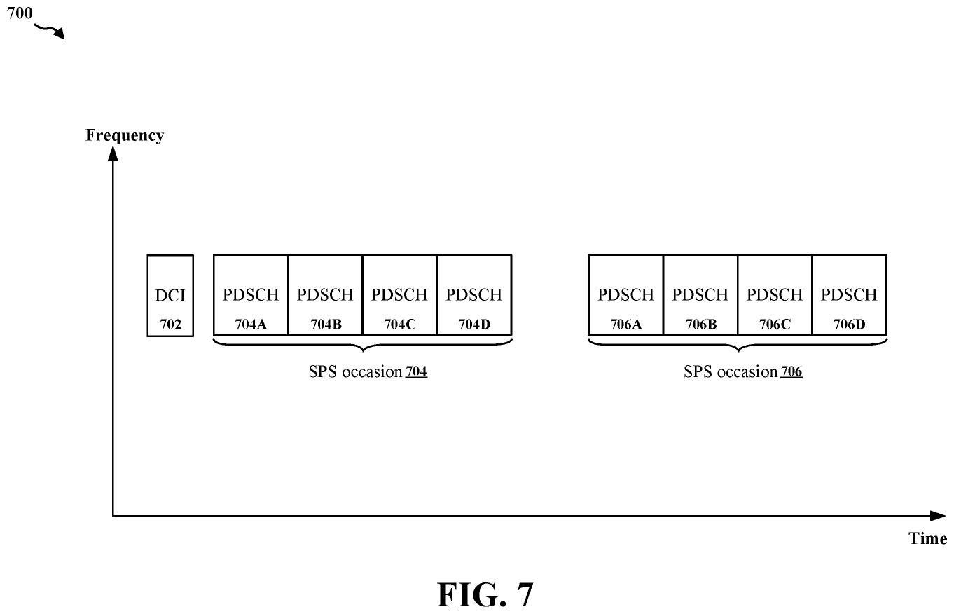

Referring now to FIG. 7, FIG. 7 is a diagram 700 illustrating an example of transmission of multiple SPS occasion scheduled by a single DCI. As illustrated in FIG. 7, the DCI 702 may schedule a first SPS occasion 704 and a second SPS occasion 706 of a same data burst. The first SPS occasion 704 may include one or more PDSCH occasions, including PDSCH occasion 704A, PDSCH occasion 704B, PDSCH occasion 704C, and PDSCH occasion 704D, each of which may include one or more PDUs. The second SPS occasion 706 may include one or more PDSCH occasions, including PDSCH occasion 706A, PDSCH occasion 706B, PDSCH occasion 706C, and PDSCH occasion 706D, each of which may include one or more PDUs. In the example illustrated in FIG. 7, the configuration for the at least one SPS occasion may include information indicative of that there is a total of two SPS occasions. For example, the multi-setSPSoccasions IE may indicate 1, which indicates that there is one subsequent SPS occasion (e.g., 706) after the initial SPS occasion (e.g., 704). In some aspects, the multi-setSPSoccasions IE may be included in the DCI 702, a MAC-CE, or a RRC signaling. Based on the configuration for the at least one SPS occasion, such as the multi-setSPSoccasions IE indicating 1, the UE may be aware that there is one subsequent SPS occasion (e.g., 706) after the initial SPS occasion (e.g., 704).

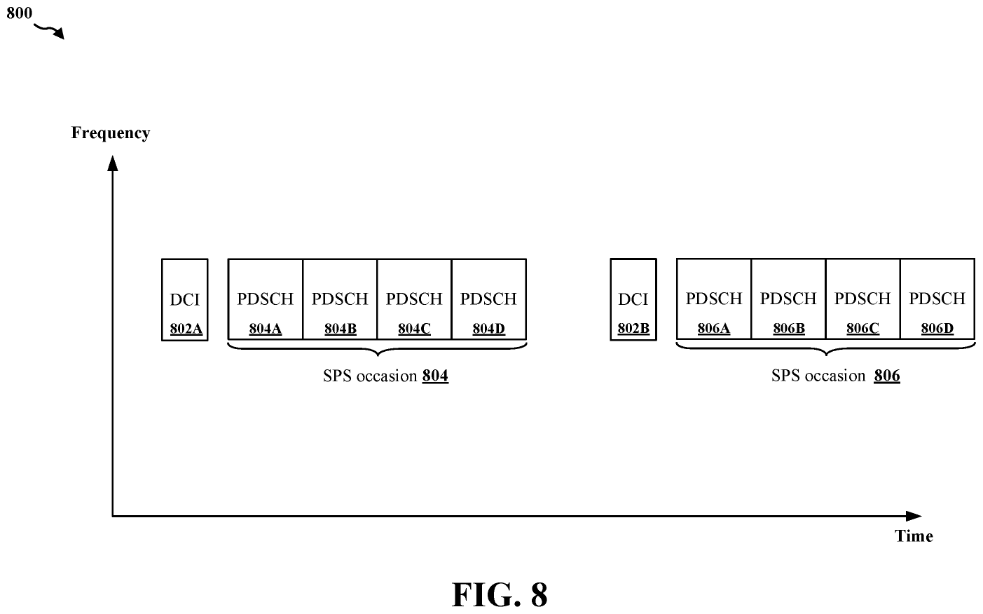

Referring now to FIG. 8, FIG. 8 is a diagram 800 illustrating an example of transmission of multiple SPS occasion scheduled by a single DCI. As illustrated in FIG. 8, the DCI 802A may schedule a first SPS occasion 804 of a data burst. The first SPS occasion 804 may include one or more PDSCH occasions, including PDSCH occasion 804A, PDSCH occasion 804B, PDSCH occasion 804C, and PDSCH occasion 804D, each of which may include one or more PDUs. A separate DCI 802B may schedule a second SPS occasion 806 of the same data burst. The second SPS occasion 806 may include one or more PDSCH occasions, including PDSCH occasion 806A, PDSCH occasion 806B, PDSCH occasion 806C, and PDSCH occasion 806D, each of which may include one or more PDUs. In the example illustrated in FIG. 8, the configuration for the at least one SPS occasion may include information indicative of that there is a total of two SPS occasions. For example, the multi-setSPSoccasions IE may indicate 1, which indicates that there is one subsequent SPS occasion (e.g., 806) after the initial SPS occasion (e.g., 804). In some aspects, the multi-setSPSoccasions IE may be included in the DCI 802A, a MAC-CE, or a RRC signaling. Based on the configuration for the at least one SPS occasion, such as the multi-setSPSoccasions IE indicating 1, the UE may be aware that there is one subsequent SPS occasion (e.g., 806) after the initial SPS occasion (e.g., 804).

In another example, based on the configuration for the at least one SPS occasion, such as the multi-setSPSoccasions IE indicating 0, the UE may be aware that there is no subsequent SPS occasion after the initial SPS occasion and may enter a sleep mode after receiving the initial SPS occasion.

Referring back to FIG. 6, in some aspects, upon receiving the SPS occasion 610, the UE 602 may remain on an active power state at 612 based on the configuration for at least one SPS occasion 606. For example, the UE 602 may determine that there is subsequent SPS occasion(s) after the SPS occasion 610 based on the quantity of SPS occasions indicated by the configuration for at least one SPS occasion 606, and accordingly remain on the active power state at 612. Based on the configuration for the at least one SPS occasion 606, such as the multi-setSPSoccasions IE indicating 1, the UE 602 may be aware that there is one subsequent SPS occasion (e.g., 616) after the initial SPS occasion (e.g., 610). Because the UE 602 may be aware that there is subsequent SPS occasions to be received, the UE 602 may determine to remain awake.

In some aspects, the UE 602 may transmit a single HARQ feedback 613B for the SPS occasion 610 and the SPS occasion 616 after receiving all of the SPS occasions. In some aspects, the UE 602 may transmit a first HARQ feedback 613A for the SPS occasion 610 after receiving the first SPS occasion 610. The UE may transmit a second HARQ feedback 613B for the SPS occasion 616. In some aspects, the UE 602 may transmit a single HARQ feedback 613B (e.g., on a same PUCCH resource) for the SPS occasion 610 and the SPS occasion 616 after receiving all of the SPS occasions if the SPS occasion 610 and the SPS occasion 616 are both scheduled by the same DCI 608. In some aspects, the UE 602 may transmit a first HARQ feedback 613A (e.g., on a first PUCCH resource) for the SPS occasion 610 after receiving the first SPS occasion 610 and transmit a second HARQ feedback 613B (e.g., on a second PUCCH resource) for the SPS occasion 616 if the SPS occasion 610 and the SPS occasion 616 are scheduled by different DCIs (e.g., respectively scheduled by DCI 608 or DCI 614).

In some aspects, a time difference 650 between the first SPS occasion 610 and the second SPS occasion 616 may correspond to a data generation periodicity, such as a video generation periodicity associated with an application associated with the burst. In some aspects, upon receiving the SPS occasion 616 from the network entity 604, the UE 602 may enter a sleep state at 618 based on the configuration for at least one SPS occasion 606. For example, the UE 602 may determine that there is no more subsequent SPS occasion after the SPS occasion 616 based on the quantity of SPS occasions indicated by the configuration for at least one SPS occasion 606, and accordingly enter the sleep state at 618. Based on the configuration for the at least one SPS occasion 606, such as the multi-setSPSoccasions IE indicating 1, the UE 602 may be aware that there is no subsequent SPS occasion after the SPS occasion 616. Because the UE 602 may be aware that there is no subsequent SPS occasions to be received, the UE 602 may determine to enter the sleep state at 618.

In some aspects, the UE 602 may enter the sleep state at 618 based on a sleep indication from the network entity 604. For example, the network entity 604 may configure a sleep indication at an end of the burst (e.g., at an end of a last PDSCH occasion of the SPS occasion 616). In some aspects, the sleep indication may not be an additional DCI. In some aspects, the sleep indication may be multiplexed with a last PDSCH occasion of the SPS occasion 616. For example, the sleep indication may be MAC-CE multiplexed with a last PDSCH occasion of the SPS occasion 616.

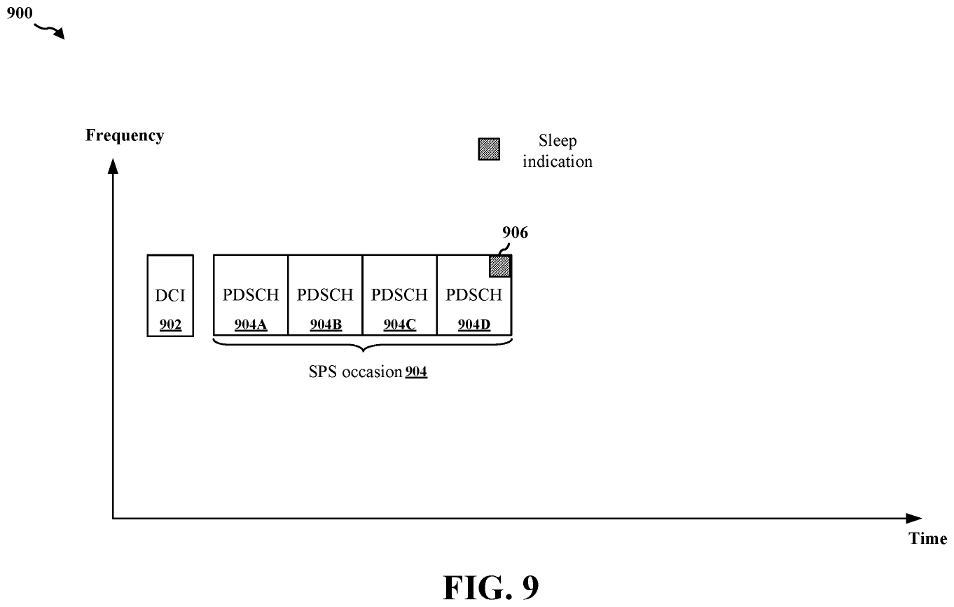

FIG. 9 is a diagram 900 illustrating an example of a sleep indication included in an SPS occasion. As illustrated in FIG. 9, a last SPS occasion 904 may be scheduled by the DCI 902. The last SPS occasion 904 may include a PDSCH occasion 904A, a PDSCH occasion 904B, a PDSCH occasion 904C, and a PDSCH occasion 904D. A sleep indication 906, which may be a MAC-CE or a different type of indication, may be multiplexed with the PDSCH occasion 904D, which may be a last PDSCH occasion in the SPS occasion 904. In some aspects, the network entity 604 may configure the UE 602, such as based on the configuration for at least one SPS occasion 606, to monitor a MAC-CE or DCI on every Kth occasion (K being a positive integer). In some aspects, the number K may be configured for the UE 602 based on an SPS configuration (e.g., per SPS configuration identifier/index) or configured for the UE 602 generally. In some aspects, number K may be configured based on RRC configuration or MAC-CE.

In some aspects, an RRC configuration may be configured to be associated with the DCI 608 or the DCI 614 that enables the burst transmission. In some aspects, the RRC configuration may be interpreted by the UE 602 as an indication that the network entity 604 has finished the transmission of the burst (and cleared the network entity 604's buffer), and the RRC configuration may be accordingly interpreted as a sleep indication. In such aspects where the RRC configuration may be interpreted as a sleep indication, there may be no additional DCI bits for the sleep indication.

In another example, the configuration for at least one SPS occasion may include information indicative of a quantity of the at least one SPS occasion, where the quantity is equal to a first value. Therefore, until the UE 602 determines that the UE 602 has received a quantity of at least one SPS occasions equal to the first value, the UE may remain in the active power state after receiving a particular SPS occasion. In some aspects, after the UE 602 determines that the UE 602 has received a quantity of at least one SPS occasions equal to the first value (e.g., after receiving a last PDSCH occasion in a last SPS occasion), the UE may enter the sleep state.

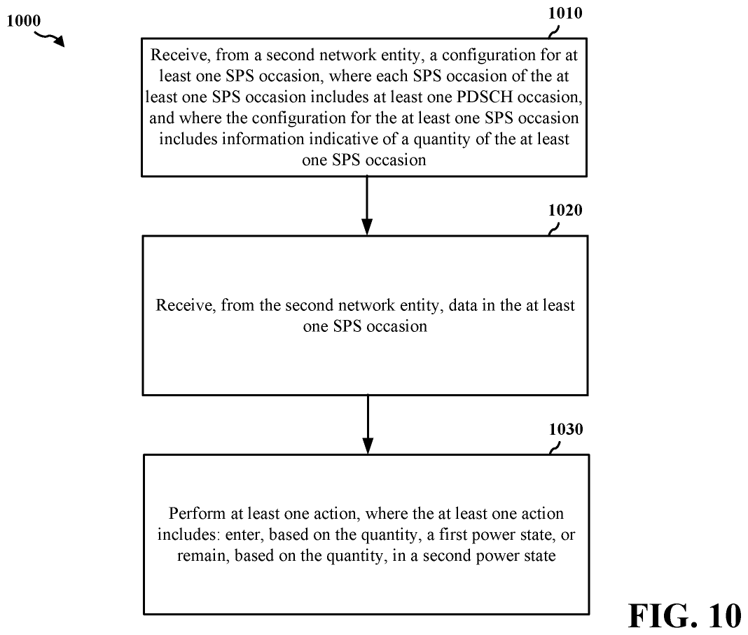

FIG. 10 is a flowchart 1000 of a method of wireless communication. The method may be performed by a first network entity, such as a UE (e.g., the UE 104, the UE 602; the apparatus 1404).

At 1010, the UE may receive, from a second network entity, a configuration for at least one SPS occasion, where each SPS occasion of the at least one SPS occasion includes at least one PDSCH occasion, and where the configuration for the at least one SPS occasion includes information indicative of a quantity of the at least one SPS occasion. For example, the UE 602 may receive, from a second network entity, a configuration (e.g., 606) for at least one SPS occasion (e.g., 610 and 616), where each SPS occasion of the at least one SPS occasion includes at least one PDSCH occasion, and where the configuration for the at least one SPS occasion includes information indicative of a quantity of the at least one SPS occasion. In some aspects, 1010 may be performed by SPS component 198.

At 1020, the UE may receive, from the second network entity, data in the at least one SPS occasion. For example, the UE 602 may receive, from the second network entity, data in the at least one SPS occasion (e.g., 610 and 616). In some aspects, 1020 may be performed by SPS component 198.

At 1030, the UE may perform at least one action, where the at least one action includes enter, based on the quantity, a first power state or remain, based on the quantity, in a second power state. For example, the UE 602 may perform at least one action, where the at least one action includes enter, based on the quantity, a first power state (e.g., at 618) or remain, based on the quantity, in a second power state (e.g., at 612). In some aspects, 1030 may be performed by SPS component 198.

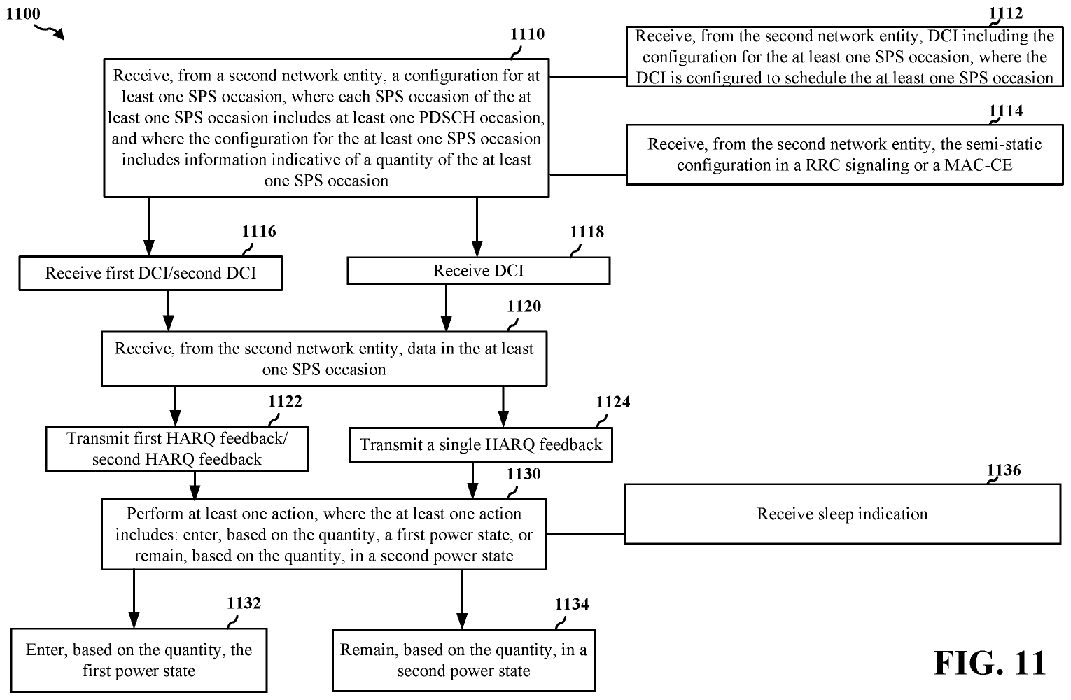

FIG. 11 is a flowchart 1100 of a method of wireless communication. The method may be performed by a first network entity, such as a UE (e.g., the UE 104, the UE 602; the apparatus 1404).

At 1110, the UE may receive, from a second network entity, a configuration for at least one SPS occasion, where each SPS occasion of the at least one SPS occasion includes at least one PDSCH occasion, and where the configuration for the at least one SPS occasion includes information indicative of a quantity of the at least one SPS occasion. For example, the UE 602 may receive, from a second network entity, a configuration (e.g., 606) for at least one SPS occasion (e.g., 610 and 616), where each SPS occasion of the at least one SPS occasion includes at least one PDSCH occasion, and where the configuration for the at least one SPS occasion includes information indicative of a quantity of the at least one SPS occasion. In some aspects, 1110 may be performed by SPS component 198. In some aspects, the configuration for the at least one SPS occasion is a semi-static configuration.

In some aspects, to receive the configuration for the at least one SPS occasion, at 1112, the UE may receive, from the second network entity, DCI including the configuration for the at least one SPS occasion, where the DCI is configured to schedule the at least one SPS occasion. For example, the UE 602 may receive, from the second network entity, DCI 608 including the configuration for the at least one SPS occasion, where the DCI 608 is configured to schedule the at least one SPS occasion. In some aspects, 1112 may be performed by SPS component 198.

In some aspects, to receive the configuration for the at least one SPS occasion, at 1114, the UE may receive, from the second network entity, the semi-static configuration in a RRC signaling or a MAC-CE. For example, the UE 602 may receive, from the second network entity, the semi-static configuration (e.g., 606) in a RRC signaling or a MAC-CE. In some aspects, 1114 may be performed by SPS component 198.

In some aspects, the quantity is greater than one and to receive the data, at 1116, the UE may receive, from the second network entity, first DCI configured to schedule an initial SPS occasion of the at least one SPS occasion and receive, from the second network entity based on the quantity, second DCI configured to schedule a subsequent SPS occasion of the at least one SPS occasion. For example, the UE 602 may receive, from the second network entity, first DCI (e.g., 608) configured to schedule an initial SPS occasion of the at least one SPS occasion and receive, from the second network entity based on the quantity, second DCI (e.g., 614) configured to schedule a subsequent SPS occasion of the at least one SPS occasion. In some aspects, 1116 may be performed by SPS component 198.

In some aspects, at 1118, the UE may receive, from the second network entity, DCI configured to schedule the at least one SPS occasion, where the DCI is associated with a RRC configuration. For example, the UE 602 may receive, from the second network entity, DCI (e.g., 608) configured to schedule the at least one SPS occasion, where the DCI is associated with a RRC configuration. In some aspects, 1118 may be performed by SPS component 198.

At 1120, the UE may receive, from the second network entity, data in the at least one SPS occasion. For example, the UE 602 may receive, from the second network entity, data in the at least one SPS occasion (e.g., 610 and 616). In some aspects, 1120 may be performed by SPS component 198. In some aspects, the data may include XR burst data. In some aspects, the at least one SPS occasion carries a single XR burst of the XR burst data. In some aspects, the at least one PDSCH occasion (e.g., each of the at least one SPS occasions) includes a plurality of PDSCH occasions.

In some aspects, at 1122, the UE may transmit, to the second network entity in a first PUCCH transmission, a first HARQ feedback associated with the initial SPS occasion and transmit, to the second network entity in a second PUCCH transmission, a second HARQ feedback associated with the subsequent SPS occasion. For example, the UE 602 may transmit, to the second network entity in a first PUCCH transmission, a first HARQ feedback (e.g., 613A) associated with the initial SPS occasion (e.g., 610) and transmit, to the second network entity in a second PUCCH transmission, a second HARQ feedback (e.g., 613B) associated with the subsequent SPS occasion (e.g., 616). In some aspects, 1122 may be performed by SPS component 198.

In some aspects, at 1124, the UE may transmit, to the second network entity in a PUCCH transmission, a single HARQ feedback associated with the at least one SPS occasion. For example, the UE 602 may transmit, to the second network entity in a PUCCH transmission, a single HARQ feedback (e.g., 613B) associated with the at least one SPS occasion (e.g., 610 and 616). In some aspects, 1124 may be performed by SPS component 198.

At 1130, the UE may perform at least one action, where the at least one action includes enter, based on the quantity, a first power state or remain, based on the quantity, in a second power state. For example, the UE 602 may perform at least one action, where the at least one action includes enter, based on the quantity, a first power state (e.g., at 618) or remain, based on the quantity, in a second power state (e.g., at 612). In some aspects, 1130 may be performed by SPS component 198.

At 1132, the UE may enter the first power state. For example, the UE 602 may enter the first power state (e.g., at 618). In some aspects, 1132 may be performed by SPS component 198. In some aspects, the quantity is equal to one, and where to enter the first power state based on the quantity, and the UE may enter, based on the quantity, the first power state after receipt of a first SPS occasion of the at least one SPS occasion. In some aspects, the quantity is equal to a first value or a second value greater than the first value, and to enter the first power state based on the quantity, the UE may enter, based on the first value, the first power state after receipt of a single SPS occasion of the at least one SPS occasion. In some aspects, the quantity is equal to a first value or a second value greater than the first value, and to enter the first power state based on the quantity, the UE may enter, based on the second value, the first power state after receipt of a plurality of SPS occasions of the at least one SPS occasion. In some aspects, to enter the first power state based on the quantity, the UE may enter the first power state after a last SPS occasion (e.g., 616) of the at least one SPS occasion. In some aspects, the UE may enter the first power state based on the RRC configuration.

At 1134, the UE may remain on the second power state. For example, the UE 602 may remain on the second power state (e.g., at 618). In some aspects, 1134 may be performed by SPS component 198. In some aspects, the quantity is equal to a first value or a second value greater than the first value, and to remain in the second power state based on the quantity, the UE may remain, based on the first value, in the second power state until receipt of a single SPS occasion of the at least one SPS occasion. In some aspects, the quantity is equal to a first value or a second value greater than the first value, and to remain in the second power state based on the quantity, the UE may remain, based on the second value, in the second power state until receipt of a plurality of SPS occasions of the at least one SPS occasion.

In some aspects, to enter the first power state based on the quantity, at 1136, the UE may receive, from the second network entity, a sleep indication. For example, the UE 602 may receive, from the second network entity, a sleep indication (e.g., in the SPS occasion at 616). In some aspects, 1136 may be performed by SPS component 198. In some aspects, the sleep indication is multiplexed with a last PDSCH occasion in a last SPS occasion of the at least one SPS occasion. In some aspects, the sleep indication is included in a MAC-CE, and where the sleep indication is indicative of an end of the data.

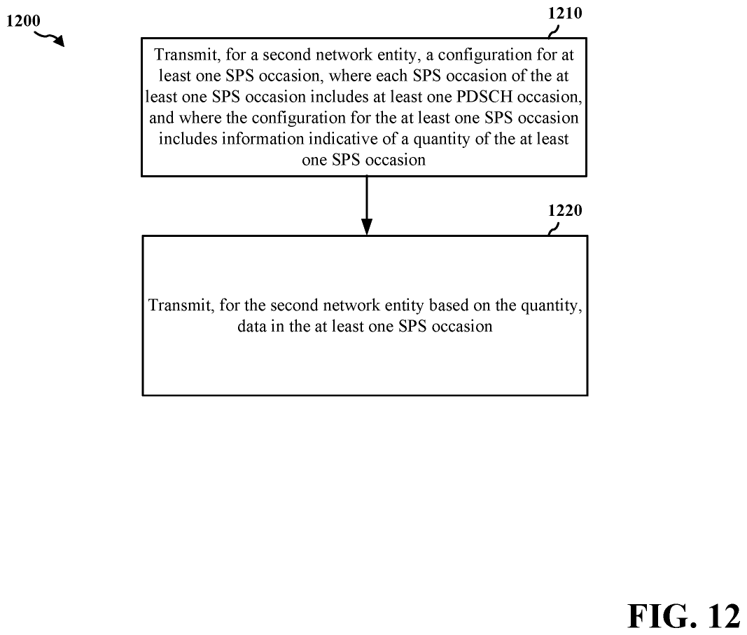

FIG. 12 is a flowchart 1200 of a method of wireless communication. The method may be performed by a first network entity (e.g., the base station 102, the network entity 604, the network entity 1402, the network entity 1502).

At 1210, the network entity may transmit, for a second network entity, a configuration for at least one SPS occasion, where each SPS occasion of the at least one SPS occasion includes at least one PDSCH occasion, and where the configuration for the at least one SPS occasion includes information indicative of a quantity of the at least one SPS occasion. For example, the network entity 604 may transmit, for a second network entity (e.g., the UE 602), a configuration (e.g., 606) for at least one SPS occasion (e.g., 610 and 616), where each SPS occasion of the at least one SPS occasion includes at least one PDSCH occasion, and where the configuration for the at least one SPS occasion includes information indicative of a quantity of the at least one SPS occasion. In some aspects, 1210 may be performed by SPS component 199. In some aspects, the configuration for the at least one SPS occasion is a semi-static configuration.

At 1220, the network entity may transmit, for the second network entity based on the quantity, data in the at least one SPS occasion. For example, the network entity 604 may transmit, for the second network entity based on the quantity, data in the at least one SPS occasion (e.g., 610 and 616). In some aspects, 1220 may be performed by SPS component 199.

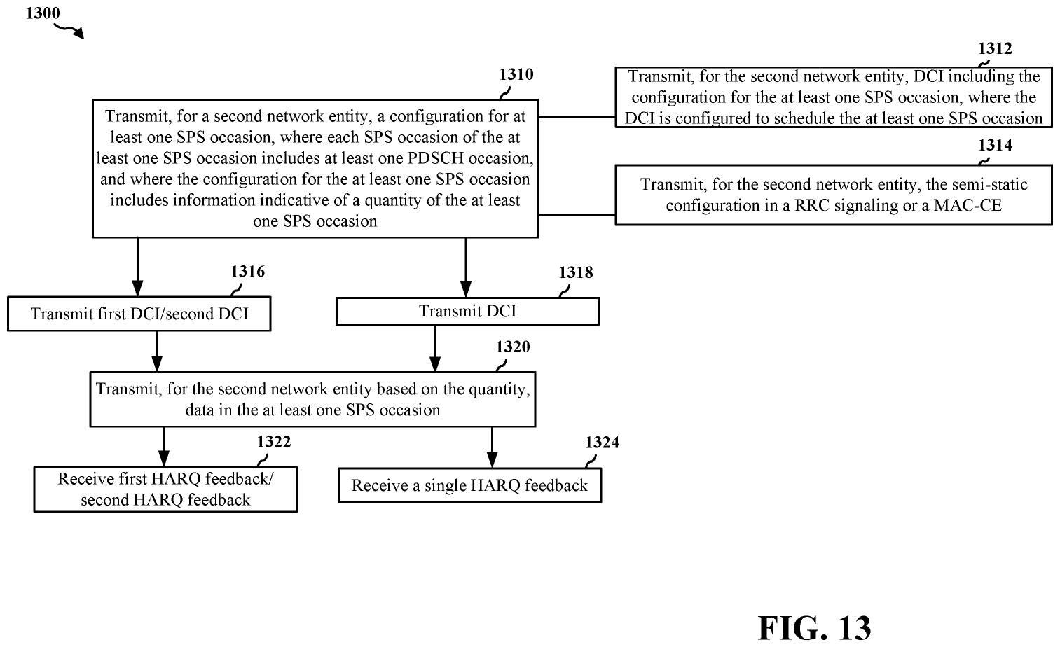

FIG. 13 is a flowchart 1300 of a method of wireless communication. The method may be performed by a first network entity (e.g., the base station 102, the network entity 604, the network entity 1402, the network entity 1502).

At 1310, the network entity may transmit, for a second network entity, a configuration for at least one SPS occasion, where each SPS occasion of the at least one SPS occasion includes at least one PDSCH occasion, and where the configuration for the at least one SPS occasion includes information indicative of a quantity of the at least one SPS occasion. For example, the network entity 604 may transmit, for a second network entity (e.g., the UE 602), a configuration (e.g., 606) for at least one SPS occasion (e.g., 610 and 616), where each SPS occasion of the at least one SPS occasion includes at least one PDSCH occasion, and where the configuration for the at least one SPS occasion includes information indicative of a quantity of the at least one SPS occasion. In some aspects, 1310 may be performed by SPS component 199. In some aspects, the configuration for the at least one SPS occasion is a semi-static configuration.

At 1312, the network entity may transmit, for the second network entity, DCI including the configuration for the at least one SPS occasion, where the DCI is configured to schedule the at least one SPS occasion. For example, the network entity 604 may transmit, for the second network entity, DCI including the configuration for the at least one SPS occasion, where the DCI is configured to schedule the at least one SPS occasion. In some aspects, 1312 may be performed by SPS component 199.

At 1314, to transmit the configuration for the at least one SPS occasion, the network entity may transmit, for the second network entity, the semi-static configuration in a RRC signaling or a MAC-CE. For example, the network entity 604 may transmit, for the second network entity, the semi-static configuration in a RRC signaling or a MAC-CE. In some aspects, 1314 may be performed by SPS component 199.

At 1316, the network entity may transmit, for the second network entity, first DCI configured to schedule an initial SPS occasion of the at least one SPS occasion and transmit, for the second network entity based on the quantity, second DCI configured to schedule a subsequent SPS occasion of the at least one SPS occasion. For example, the network entity 604 may transmit, for the second network entity, first DCI (e.g., 608) configured to schedule an initial SPS occasion (e.g., 610) of the at least one SPS occasion and transmit, for the second network entity based on the quantity, second DCI (e.g., 614) configured to schedule a subsequent SPS occasion (e.g., 616) of the at least one SPS occasion. In some aspects, 1316 may be performed by SPS component 199.

At 1318, the network entity may receive DCI configured to schedule the at least one SPS occasion. For example, the network entity 604 may receive DCI (e.g., 608) configured to schedule the at least one SPS occasion (e.g., 610 and 616). In some aspects, 1318 may be performed by SPS component 199.

At 1320, the network entity may transmit, for the second network entity based on the quantity, data in the at least one SPS occasion. For example, the network entity 604 may transmit, for the second network entity based on the quantity, data in the at least one SPS occasion (e.g., 610 and 616). In some aspects, 1320 may be performed by SPS component 199.

At 1322, the network entity may receive, from the second network entity in a first PUCCH transmission, a first HARQ feedback associated with the initial SPS occasion and receive, from the second network entity in a second PUCCH transmission, a second HARQ feedback associated with the subsequent SPS occasion. For example, the network entity 604 may receive, from the second network entity in a first PUCCH transmission, a first HARQ feedback (e.g., 613A) associated with the initial SPS occasion and receive, from the second network entity in a second PUCCH transmission, a second HARQ feedback (e.g., 613B) associated with the subsequent SPS occasion. In some aspects, 1322 may be performed by SPS component 199.

At 1324, the network entity may receive, from the second network entity in a PUCCH transmission, a single HARQ feedback associated with the at least one SPS occasion. For example, the network entity 604 may receive, from the second network entity in a PUCCH transmission, a single HARQ feedback (e.g., 613B) associated with the at least one SPS occasion. In some aspects, 1324 may be performed by SPS component 199.

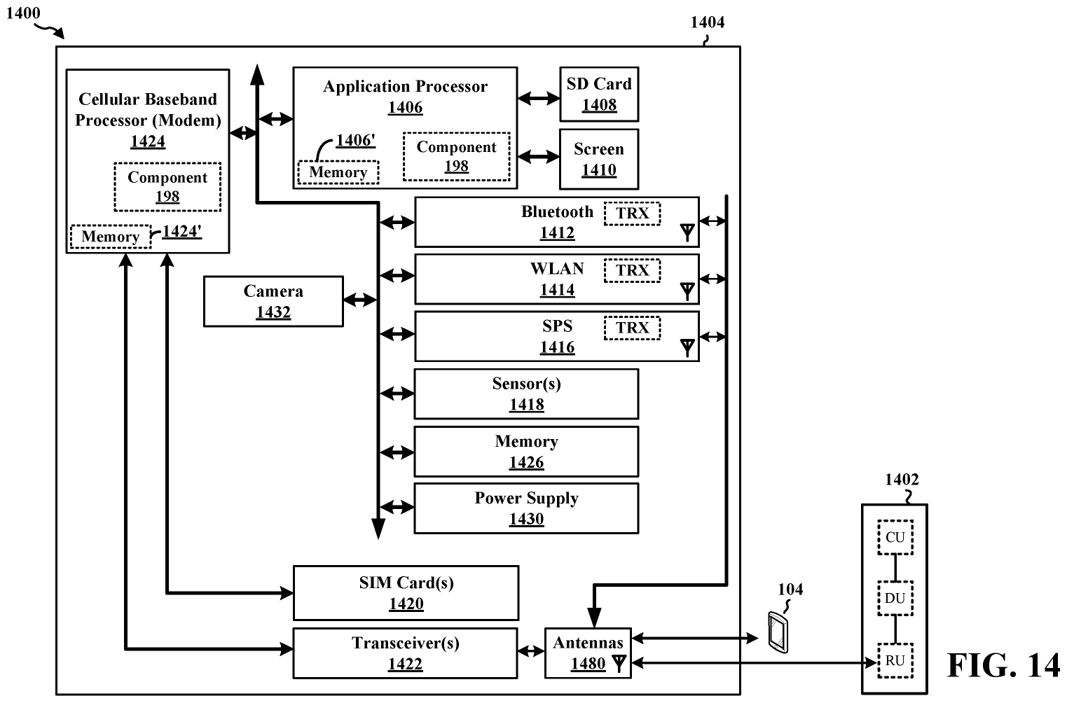

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, a satellite system module 1416 (e.g., GNSS module), one or more sensor modules 1418 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the satellite system module 1416 may include an on-chip transceiver (TRX)/receiver (RX). The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described herein. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see 350 of FIG. 3) and include the additional modules of the apparatus 1404.

As discussed herein, the SPS component 198 may be configured to receive, from a second network entity, a configuration for at least one SPS occasion, where each SPS occasion of the at least one SPS occasion includes at least one PDSCH occasion, and where the configuration for the at least one SPS occasion includes information indicative of a quantity of the at least one SPS occasion. In some aspects, the SPS component 198 may be further configured to receive, from the second network entity, data in the at least one SPS occasion. In some aspects, the SPS component 198 may be further configured to perform at least one action, where the at least one action includes: enter, based on the quantity, a first power state, or remain, based on the quantity, in a second power state.

The SPS component 198 may be within the cellular baseband processor 1424, the application processor 1406, or both the cellular baseband processor 1424 and the application processor 1406. The SPS component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, includes means for receiving, from a second network entity, a configuration for at least one SPS occasion, where each SPS occasion of the at least one SPS occasion includes at least one PDSCH occasion, and where the configuration for the at least one SPS occasion includes information indicative of a quantity of the at least one SPS occasion. In some aspects, the apparatus 1404 may further include means for receiving, from the second network entity, data in the at least one SPS occasion. In some aspects, the apparatus 1404 may further include means for performing at least one action, where the at least one action includes enter, based on the quantity, a first power state, or remain, based on the quantity, in a second power state. In some aspects, the apparatus 1404 may further include means for receiving, from the second network entity, DCI including the configuration for the at least one SPS occasion, where the DCI is configured to schedule the at least one SPS occasion. In some aspects, the apparatus 1404 may further include means for receiving, from the second network entity, the semi-static configuration in a RRC signaling or a MAC-CE. In some aspects, the apparatus 1404 may further include means for entering, based on the quantity, the first power state after receipt of a first SPS occasion of the at least one SPS occasion. In some aspects, the apparatus 1404 may further include means for entering, based on the first value, the first power state after receipt of a single SPS occasion of the at least one SPS occasion. In some aspects, the apparatus 1404 may further include means for entering, based on the second value, the first power state after receipt of a plurality of SPS occasions of the at least one SPS occasion. In some aspects, the apparatus 1404 may further include means for remaining, based on the first value, in the second power state until receipt of a single SPS occasion of the at least one SPS occasion. In some aspects, the apparatus 1404 may further include means for remaining, based on the second value, in the second power state until receipt of a plurality of SPS occasions of the at least one SPS occasion. In some aspects, the apparatus 1404 may further include means for entering the first power state after a last SPS occasion of the at least one SPS occasion. In some aspects, the apparatus 1404 may further include means for receiving, from the second network entity, first DCI configured to schedule an initial SPS occasion of the at least one SPS occasion. In some aspects, the apparatus 1404 may further include means for receiving, from the second network entity based on the quantity, second DCI configured to schedule a subsequent SPS occasion of the at least one SPS occasion. In some aspects, the apparatus 1404 may further include means for transmitting, to the second network entity in a first PUCCH transmission, a first HARQ feedback associated with the initial SPS occasion. In some aspects, the apparatus 1404 may further include means for transmitting, to the second network entity in a second PUCCH transmission, a second HARQ feedback associated with the subsequent SPS occasion. In some aspects, the apparatus 1404 may further include means for transmitting, to the second network entity in a PUCCH transmission, a single HARQ feedback associated with the at least one SPS occasion. In some aspects, the apparatus 1404 may further include means for receiving, from the second network entity, a sleep indication. In some aspects, the apparatus 1404 may further include means for receiving, from the second network entity, information indicative of MAC-CE or DCI on every Kth PDSCH occasion in the at least one SPS occasion, where K is a positive integer. In some aspects, the apparatus 1404 may further include means for monitoring the MAC-CE or the DCI based on the information indicative of the MAC-CE or the DCI. In some aspects, the apparatus 1404 may further include means for receiving, from the second network entity, DCI configured to schedule the at least one SPS occasion, where the DCI is associated with a RRC configuration. In some aspects, the apparatus 1404 may further include means for entering the first power state based on the RRC configuration. The means may be the SPS component 198 of the apparatus 1404 configured to perform the functions recited by the means. As described herein, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

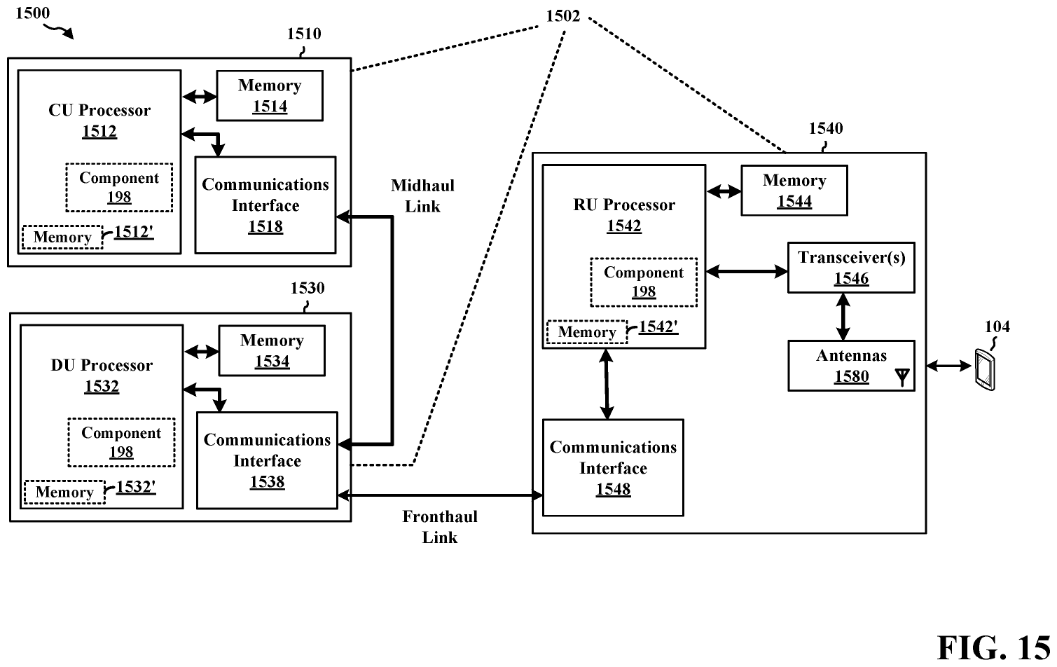

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the SPS component 199 may be configured to transmit, for a second network entity, a configuration for at least one SPS occasion, where each SPS occasion of the at least one SPS occasion includes at least one PDSCH occasion, and where the configuration for the at least one SPS occasion includes information indicative of a quantity of the at least one SPS occasion. In some aspects, the SPS component 199 may be further configured to transmit, for the second network entity based on the quantity, data in the at least one SPS occasion. The SPS component 199 may be within one or more processors of one or more of the CU 1510, DU 1530, and the RU 1540. The SPS component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 includes means for transmitting, for a second network entity, a configuration for at least one SPS occasion, where each SPS occasion of the at least one SPS occasion includes at least one PDSCH occasion, and where the configuration for the at least one SPS occasion includes information indicative of a quantity of the at least one SPS occasion. In some aspects, the network entity 1502 may further include means for transmitting, for the second network entity based on the quantity, data in the at least one SPS occasion. In some aspects, the network entity 1502 may further include means for transmitting, for the second network entity, DCI including the configuration for the at least one SPS occasion, where the DCI is configured to schedule the at least one SPS occasion. In some aspects, the network entity 1502 may further include means for transmitting, for the second network entity, the semi-static configuration in a RRC signaling or a MAC-CE. In some aspects, the network entity 1502 may further include means for receiving, from the second network entity in a first PUCCH transmission, a first HARQ feedback associated with the initial SPS occasion. In some aspects, the network entity 1502 may further include means for receiving, from the second network entity in a second PUCCH transmission, a second HARQ feedback associated with the subsequent SPS occasion. In some aspects, the network entity 1502 may further include means for receiving, from the second network entity in a PUCCH transmission, a single HARQ feedback associated with the at least one SPS occasion. In some aspects, the network entity 1502 may further include means for transmitting, for the second network entity, a sleep indication. The means may be the SPS component 199 of the network entity 1502 configured to perform the functions recited by the means. As described herein, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a first network entity for wireless communication, including: a memory; and at least one processor coupled to the memory, where the at least one processor is configured to: receive, from a second network entity, a configuration for at least one semi-persistent scheduling (SPS) occasion, where each SPS occasion of the at least one SPS occasion includes at least one physical downlink shared channel (PDSCH) occasion, and where the configuration for the at least one SPS occasion includes information indicative of a quantity of the at least one SPS occasion; receive, from the second network entity, data in the at least one SPS occasion; and perform at least one action, where the at least one action includes: enter, based on the quantity, a first power state, or remain, based on the quantity, in a second power state.
Aspect 2 is the first network entity of aspect 1, where to receive the configuration for the at least one SPS occasion, the at least one processor is configured to: receive, from the second network entity, downlink control information (DCI) including the configuration for the at least one SPS occasion, where the DCI is configured to schedule the at least one SPS occasion.
Aspect 3 is the first network entity of any of aspects 1-2, where the configuration for the at least one SPS occasion is a semi-static configuration.
Aspect 4 is the first network entity of aspect 3, where to receive the configuration for the at least one SPS occasion, the at least one processor is configured to: receive, from the second network entity, the semi-static configuration in a radio resource control (RRC) signaling or a medium access control (MAC) control element (MAC-CE).
Aspect 5 is the first network entity of any of aspects 1-4, where the quantity is equal to one, and where to enter the first power state based on the quantity, the at least one processor is configured to: enter, based on the quantity, the first power state after receipt of a first SPS occasion of the at least one SPS occasion.
Aspect 6 is the first network entity of any of aspects 1-4, where the quantity is equal to a first value or a second value greater than the first value, and where at least one of: to enter the first power state based on the quantity, the at least one processor is configured to enter, based on the first value, the first power state after receipt of a single SPS occasion of the at least one SPS occasion; or to enter the first power state based on the quantity, the at least one processor is configured to enter, based on the second value, the first power state after receipt of a plurality of SPS occasions of the at least one SPS occasion.
Aspect 7 is the first network entity of any of aspects 1-4, where the quantity is equal to a first value or a second value greater than the first value, and where at least one of: to remain in the second power state based on the quantity, the at least one processor is configured to remain, based on the first value, in the second power state until receipt of a single SPS occasion of the at least one SPS occasion; or to remain in the second power state based on the quantity, the at least one processor is configured to remain, based on the second value, in the second power state until receipt of a plurality of SPS occasions of the at least one SPS occasion.
Aspect 8 is the first network entity of any of aspects 1-4, where to enter the first power state based on the quantity, the at least one processor is configured to: enter the first power state after a last SPS occasion of the at least one SPS occasion.
Aspect 9 is the first network entity of any of aspects 1-4, where the quantity is greater than one, and where to receive the data, the at least one processor is configured to: receive, from the second network entity, first downlink control information (DCI) configured to schedule an initial SPS occasion of the at least one SPS occasion; and receive, from the second network entity based on the quantity, second DCI configured to schedule a subsequent SPS occasion of the at least one SPS occasion.
Aspect 10 is the first network entity of aspect 9, where the at least one processor is configured to: transmit, to the second network entity in a first physical uplink control channel (PUCCH) transmission, a first hybrid automatic repeat request (HARQ) feedback associated with the initial SPS occasion; and transmit, to the second network entity in a second PUCCH transmission, a second HARQ feedback associated with the subsequent SPS occasion.
Aspect 11 is the first network entity of any of aspects 1-9, where the at least one processor is configured to: transmit, to the second network entity in a physical uplink control channel (PUCCH) transmission, a single hybrid automatic repeat request (HARQ) feedback associated with the at least one SPS occasion.
Aspect 12 is the first network entity of any of aspects 1-11, where to enter the first power state based on the quantity, the at least one processor is configured to: receive, from the second network entity, a sleep indication.
Aspect 13 is the first network entity of aspect 12, where the sleep indication is multiplexed with a last PDSCH occasion in a last SPS occasion of the at least one SPS occasion.
Aspect 14 is the first network entity of aspect 12, where the sleep indication is included in a medium access control (MAC) control element (MAC-CE), and where the sleep indication is indicative of an end of the data.
Aspect 15 is the first network entity any of aspects 1-14, where the at least one processor is configured to: receive, from the second network entity, information indicative of medium access control (MAC) control element (MAC-CE) or downlink control information (DCI) on every Kth PDSCH occasion in the at least one SPS occasion, where K is a positive integer; and monitor the MAC-CE or the DCI based on the information indicative of the MAC-CE or the DCI.
Aspect 16 is the first network entity of any of aspects 1-8 or 11-15, where the at least one processor is configured to: receive, from the second network entity, downlink control information (DCI) configured to schedule the at least one SPS occasion, where the DCI is associated with a radio resource control (RRC) configuration.
Aspect 17 is the first network entity of aspect 16, where to enter the first power state based on the quantity, the at least one processor is configured to: enter the first power state based on the RRC configuration.
Aspect 18 is the first network entity of any of aspects 1-17, where the data includes extended reality (XR) burst data.
Aspect 19 is the first network entity of aspect 18, where the at least one SPS occasion carries a single XR burst of the XR burst data.
Aspect 20 is the first network entity of any of aspects 1-19, where the at least one PDSCH occasion includes a plurality of PDSCH occasions.
Aspect 21 is a first network entity for wireless communication, including: a memory; and at least one processor coupled to the memory, where the at least one processor is configured to: transmit, for a second network entity, a configuration for at least one semi-persistent scheduling (SPS) occasion, where each SPS occasion of the at least one SPS occasion includes at least one physical downlink shared channel (PDSCH) occasion, and where the configuration for the at least one SPS occasion includes information indicative of a quantity of the at least one SPS occasion; and transmit, for the second network entity based on the quantity, data in the at least one SPS occasion.
Aspect 22 is the first network entity of aspect 21, where to transmit the configuration for the at least one SPS occasion, the at least one processor is configured to: transmit, for the second network entity, downlink control information (DCI) including the configuration for the at least one SPS occasion, where the DCI is configured to schedule the at least one SPS occasion.
Aspect 23 is the first network entity of any of aspects 21-22, where the configuration for the at least one SPS occasion is a semi-static configuration.
Aspect 24 is the first network entity of aspect 23, where to transmit the configuration for the at least one SPS occasion, the at least one processor is configured to: transmit, for the second network entity, the semi-static configuration in a radio resource control (RRC) signaling or a medium access control (MAC) control element (MAC-CE).
Aspect 25 is the first network entity of any of aspects 21-24, where the quantity is greater than one, and where to transmit the data, the at least one processor is configured to: transmit, for the second network entity, first downlink control information (DCI) configured to schedule an initial SPS occasion of the at least one SPS occasion; and transmit, for the second network entity based on the quantity, second DCI configured to schedule a subsequent SPS occasion of the at least one SPS occasion.
Aspect 26 is the first network entity of aspect 25, where the at least one processor is configured to: receive, from the second network entity in a first physical uplink control channel (PUCCH) transmission, a first hybrid automatic repeat request (HARQ) feedback associated with the initial SPS occasion; and receive, from the second network entity in a second PUCCH transmission, a second HARQ feedback associated with the subsequent SPS occasion.
Aspect 27 is the first network entity of any of aspects 21-25, where the at least one processor is configured to: receive, from the second network entity in a physical uplink control channel (PUCCH) transmission, a single hybrid automatic repeat request (HARQ) feedback associated with the at least one SPS occasion.
Aspect 28 is the first network entity of any of aspects 21-27, where the at least one processor is configured to: transmit, for the second network entity, a sleep indication.
Aspect 29 is the first network entity of aspect 28, where the sleep indication is multiplexed with a last PDSCH occasion in a last SPS occasion of the at least one SPS occasion.
Aspect 30 is the first network entity of aspects 28, where the sleep indication is included in a medium access control (MAC) control element (MAC-CE), and where the sleep indication is indicative of an end of the data.
Aspect 31 is a method of wireless communication for implementing any of aspects 1 to 20.
Aspect 32 is an apparatus for wireless communication including means for implementing any of aspects 1 to 20.
Aspect 33 is a computer-readable medium (e.g., a non-transitory computer-readable medium) having code stored thereon that, when executed by an apparatus, causes the apparatus to implement any of aspects 1 to 20.
Aspect 34 is a method of wireless communication for implementing any of aspects 21 to 30.
Aspect 35 is an apparatus for wireless communication including means for implementing any of aspects 21 to 30.
Aspect 36 is a computer-readable medium (e.g., a non-transitory computer-readable medium) having code stored thereon that, when executed by an apparatus, causes the apparatus to implement any of aspects 21 to 30.

What is claimed is:

1. A first network entity for wireless communication, comprising:
a memory; and
at least one processor coupled to the memory, wherein the at least one processor is configured to:
receive, from a second network entity, a configuration for at least one semi-persistent scheduling (SPS) occasion, wherein each SPS occasion of the at least one SPS occasion comprises at least one physical downlink shared channel (PDSCH) occasion, and wherein the configuration for the at least one SPS occasion comprises information indicative of a quantity of the at least one SPS occasion;
receive, from the second network entity, data in the at least one SPS occasion; and
perform at least one action, wherein the at least one action includes:
enter, based on the quantity, a first power state, or
remain, based on the quantity, in a second power state.

2. The first network entity of claim 1, wherein to receive the configuration for the at least one SPS occasion, the at least one processor is configured to:
receive, from the second network entity, downlink control information (DCI) comprising the configuration for the at least one SPS occasion, wherein the DCI is configured to schedule the at least one SPS occasion.

3. The first network entity of claim 1, wherein the configuration for the at least one SPS occasion is a semi-static configuration.

4. The first network entity of claim 3, wherein to receive the configuration for the at least one SPS occasion, the at least one processor is configured to:
receive, from the second network entity, the semi-static configuration in a radio resource control (RRC) signaling or a medium access control (MAC) control element (MAC-CE).

5. The first network entity of claim 1, wherein the quantity is equal to one, and wherein to enter the first power state based on the quantity, the at least one processor is configured to:
enter, based on the quantity, the first power state after receipt of a first SPS occasion of the at least one SPS occasion.

6. The first network entity of claim 1, wherein the quantity is equal to a first value or a second value greater than the first value, and wherein at least one of:
to enter the first power state based on the quantity, the at least one processor is configured to enter, based on the first value, the first power state after receipt of a single SPS occasion of the at least one SPS occasion; or
to enter the first power state based on the quantity, the at least one processor is configured to enter, based on the second value, the first power state after receipt of a plurality of SPS occasions of the at least one SPS occasion.

7. The first network entity of claim 1, wherein the quantity is equal to a first value or a second value greater than the first value, and wherein at least one of:
to remain in the second power state based on the quantity, the at least one processor is configured to remain, based on the first value, in the second power state until receipt of a single SPS occasion of the at least one SPS occasion; or
to remain in the second power state based on the quantity, the at least one processor is configured to remain, based on the second value, in the second power state until receipt of a plurality of SPS occasions of the at least one SPS occasion.

8. The first network entity of claim 1, wherein to enter the first power state based on the quantity, the at least one processor is configured to:
enter the first power state after a last SPS occasion of the at least one SPS occasion.

9. The first network entity of claim 1, wherein the quantity is greater than one, and wherein to receive the data, the at least one processor is configured to:
receive, from the second network entity, first downlink control information (DCI) configured to schedule an initial SPS occasion of the at least one SPS occasion; and
receive, from the second network entity based on the quantity, second DCI configured to schedule a subsequent SPS occasion of the at least one SPS occasion.

10. The first network entity of claim 9, wherein the at least one processor is configured to:
transmit, to the second network entity in a first physical uplink control channel (PUCCH) transmission, a first hybrid automatic repeat request (HARQ) feedback associated with the initial SPS occasion; and
transmit, to the second network entity in a second PUCCH transmission, a second HARQ feedback associated with the subsequent SPS occasion.

11. The first network entity of claim 1, wherein the at least one processor is configured to:
transmit, to the second network entity in a physical uplink control channel (PUCCH) transmission, a single hybrid automatic repeat request (HARQ) feedback associated with the at least one SPS occasion.

12. The first network entity of claim 1, wherein to enter the first power state based on the quantity, the at least one processor is configured to:
receive, from the second network entity, a sleep indication.

13. The first network entity of claim 12, wherein the sleep indication is multiplexed with a last PDSCH occasion in a last SPS occasion of the at least one SPS occasion.

14. The first network entity of claim 12, wherein the sleep indication is included in a medium access control (MAC) control element (MAC-CE), and wherein the sleep indication is indicative of an end of the data.

15. The first network entity of claim 1, wherein the at least one processor is configured to:
receive, from the second network entity, information indicative of medium access control (MAC) control element (MAC-CE) or downlink control information (DCI) on every Kth PDSCH occasion in the at least one SPS occasion, wherein K is a positive integer; and
monitor the MAC-CE or the DCI based on the information indicative of the MAC-CE or the DCI.

16. The first network entity of claim 1, wherein the at least one processor is configured to:
receive, from the second network entity, downlink control information (DCI) configured to schedule the at least one SPS occasion, wherein the DCI is associated with a radio resource control (RRC) configuration.

17. The first network entity of claim 16, wherein to enter the first power state based on the quantity, the at least one processor is configured to:
enter the first power state based on the RRC configuration.

18. The first network entity of claim 1, wherein the data comprises extended reality (XR) burst data.

19. The first network entity of claim 18, wherein the at least one SPS occasion carries a single XR burst of the XR burst data.

20. The first network entity of claim 1, wherein the at least one PDSCH occasion includes a plurality of PDSCH occasions.

21. A first network entity for wireless communication, comprising:
a memory; and
at least one processor coupled to the memory, wherein the at least one processor is configured to:
transmit, for a second network entity, a configuration for at least one semi-persistent scheduling (SPS) occasion, wherein each SPS occasion of the at least one SPS occasion comprises at least one physical downlink shared channel (PDSCH) occasion, and wherein the configuration for the at least one SPS occasion comprises information indicative of a quantity of the at least one SPS occasion; and
transmit, for the second network entity based on the quantity, data in the at least one SPS occasion.

22. The first network entity of claim 21, wherein to transmit the configuration for the at least one SPS occasion, the at least one processor is configured to:
transmit, for the second network entity, downlink control information (DCI) comprising the configuration for the at least one SPS occasion, wherein the DCI is configured to schedule the at least one SPS occasion.

23. The first network entity of claim 21, wherein the configuration for the at least one SPS occasion is a semi-static configuration.

24. The first network entity of claim 23, wherein to transmit the configuration for the at least one SPS occasion, the at least one processor is configured to:
transmit, for the second network entity, the semi-static configuration in a radio resource control (RRC) signaling or a medium access control (MAC) control element (MAC-CE).

25. The first network entity of claim 21, wherein the quantity is greater than one, and wherein to receive the data, the at least one processor is configured to:
transmit, for the second network entity, first downlink control information (DCI) configured to schedule an initial SPS occasion of the at least one SPS occasion; and
transmit, for the second network entity based on the quantity, second DCI configured to schedule a subsequent SPS occasion of the at least one SPS occasion.

26. The first network entity of claim 25, wherein the at least one processor is configured to:
receive, from the second network entity in a first physical uplink control channel (PUCCH) transmission, a first hybrid automatic repeat request (HARQ) feedback associated with the initial SPS occasion; and
receive, from the second network entity in a second PUCCH transmission, a second HARQ feedback associated with the subsequent SPS occasion.

27. The first network entity of claim 21, wherein the at least one processor is configured to:
receive, from the second network entity in a physical uplink control channel (PUCCH) transmission, a single hybrid automatic repeat request (HARQ) feedback associated with the at least one SPS occasion.

28. The first network entity of claim 21, wherein the at least one processor is configured to:
transmit, for the second network entity, a sleep indication.

29. The first network entity of claim 28, wherein the sleep indication is multiplexed with a last PDSCH occasion in a last SPS occasion of the at least one SPS occasion.

30. The first network entity of claim 28, wherein the sleep indication is included in a medium access control (MAC) control element (MAC-CE), and wherein the sleep indication is indicative of an end of the data.
